(19) United States
(12) Patent Application Publication
(10) Pub. No.: US 2017/0167612 A1
(43) Pub. Date: Jun. 15, 2017

(54) Split packing gland inserts and packing retainers for a stuffing box

(71) Applicant: Scott Finnestad, Red Deer (CA)

(72) Inventor: Scott Finnestad, Red Deer (CA)

(21) Appl. No.: 14/968,861

(22) Filed: Dec. 14, 2015

(51) Int. Cl. F16J 15/28; E21B 43/12

(52) U.S. Cl. CPC F16J 15/28; E21B 43/127; E21B 2043/125

(57) ABSTRACT

In one aspect there is provided a packing gland insert having a longitudinal axis for use with a packing gland of a stuffing box and a polished rod. The insert comprises a plurality of segments and a plurality of spacer members to join each segment with any adjacent segments. When all of the plurality of segments are joined, then the packing gland insert is in an operating configuration, a space results between each set of adjacent segments and the plurality of segments form an inner bore along the longitudinal axis of the insert. The inner bore is of such dimensions so as to allow the packing gland insert to have a close, sliding fit against exterior of the polished rod.

### FIELD OF THE INVENTION

The present invention relates to packing gland inserts and packing retainers for a stuffing box. More particularly, the invention relates to packing gland inserts and packing retainers that are split.

### BACKGROUND OF THE INVENTION

The background information discussed below is presented to better illustrate the novelty and usefulness of the present invention. This background information is not admitted prior art.

A stuffing box is an assembly which is used to house a gland seal. It is used to prevent leakage of fluid, such as water or steam, between sliding or turning parts of machine elements. Typically it is used to seal a rotating or reciprocating shaft against a fluid using “packing”. In oil well applications, the pumping action of a beam pump, commonly known as a “pumpjack”, moves a rod string in a reciprocating motion to drive a downhole pump.

For example, an oil well sucker rod pump assembly may include a pump located in the production tubing of an oil producing well, below the level of the liquid in the well. The pump is operated by a string of reciprocating sucker rods that extend through the production tubing from the pump to the surface. The rods are reciprocated by the pumpjack located at the surface. When the fluid being pumped reaches the surface, it is directed into a lateral flow line by a stuffing box mounted on the wellhead. The stuffing box has an opening through which the top sucker rod extends. Seals or packing located in the stuffing box allow the sucker rods to reciprocate in the opening while preventing the pumped fluid from flowing through the top opening. The top sucker rod is usually a special rod, called a “polished rod”, with an outer surface that is machined to a very smooth finish to reduce the friction between the rod and the seals or packing in the stuffing box. Even with a very smooth “polished rod”, the friction generated by the reciprocation of the polished rod, however well machined, will produce heat and contributed to the deterioration of the seals and packing.

The polished rod extends through an axial bore of a stuffing box. The stuffing box contains packing which forms a seal against the polished rod. If the polished rod is not axially aligned with the axial bore of the stuffing box, lateral pressure is exerted upon the stuffing box by the polished rod. This lateral pressure leads to wear and premature failure of both the packing and the polished rod.

In order to address problems of wear due to improper alignment, stuffing boxes have been developed that are self aligning. U.S. Pat. No. 3,887,196 (Renfrow) discloses a self aligning stuffing box in which a first body provides a socket and a second body provides a ball. The ball and socket engagement enables limited universal movement between the first body and the second body. U.S. Pat. No. 6,412,783 (Finnestad) discloses an alternative configuration of a self aligning stuffing box for pumpjacks.

Regardless of the type of stuffing box, most stuffing boxes will utilize one or more packing glands or packed glands for sealing the polished rod and maintaining the packing in the stuffing box. Packing glands will typically have an inner insert made of a material which is softer than the polished rod, e.g. bronze; see FIGS. 1 and 2. This softer inner material reduces scuffing on, and damage to, the polished rod as it reciprocates in and out of the stuffing box. However, being a softer material, the packing gland insert will experience wear over time and will need to be replaced at periodic intervals.

Traditionally, when replacing the packing gland insert, the packing gland will be unthreaded from the stuffing box and then slid up off the top end of the polished rod. However, the top end of the polished rod is typically several feet above the ground. Moreover, the polished rod will also typically be connected to the head of a pump-jack and will need to be disconnected therefrom, in order to remove and replace a typical packing gland and insert. As such, it is often fairly difficult and labour intensive to replace such wearable inserts, i.e. having to slide such inserts over top of a polished rod.

Similarly, stuffing boxes typically comprise other wearable bearing members which surround the polished rod, such as top and bottom packing retainers (see FIG. 1). These packing retainers, like the packing gland insert, are typically made of softer material to reduce scuffing on, and damage to, the polished rod. Like the packing gland insert, such retainers, or retainer rings, will also require to be slid up off the top end of a polished rod when they are replaced. Therefore, what is needed is are packing glands and packing retainers which can easily be replaced, without need to disconnect a polished rod from the pump-jack.

### BRIEF DESCRIPTION OF THE DRAWINGS

Referring to the drawings, several aspects of the present invention are illustrated by way of example, and not by way of limitation, in detail in the figures, wherein:

FIG. 1 is an exploded perspective view of a PRIOR ART stuffing box, showing a threaded packing gland with insert, top packing retainer and bottom packing retainer;

FIG. 2 is a bottom perspective view of a PRIOR ART embodiment of a threaded packing gland with insert;

FIG. 3a is a bottom/side perspective view of one embodiment of a threaded packing gland with insert of the present invention, showing the insert in an operating configuration and positioned within the threaded packing gland;

FIG. 3b is a bottom/side perspective view of the threaded packing gland with insert of the embodiment of FIG. 3a, showing the insert in an operating configuration and positioned outside and adjacent the threaded packing gland;

FIG. 4a is a bottom/side perspective view of the insert for a threaded packing gland, of the embodiment of FIG. 3a, showing the plurality of insert segments joined together by means of a plurality of tab members;

FIG. 4b is a bottom/side perspective view of the insert for a threaded packing gland, of the embodiment of FIG. 3a, showing the plurality of insert segments separated from each other in a disassembled configuration;

FIG. 5a is a perspective view of the insert for a threaded packing gland, of the embodiment of FIG. 3a, showing the plurality of insert segments separated from each other in a disassembled configuration;

FIG. 5b is a perspective, enlarged view of a portion of FIG. 5a, illustrating one of the spacer members;

FIG. 6 is a perspective view of the threaded packing gland with insert of the embodiment of FIG. 3a, showing the insert in a disassembled configuration with one segment positioned inside the threaded packing gland and another segment positioned outside and adjacent the threaded packing gland;

FIGS. 7a and 7b are perspective views of one embodiment of a packing retainer assembly, partially captured by a packing gland ring, shown in an operating configuration and a partially disassembled configuration, respectively;

FIGS. 8a and 8b are additional perspective views of the packing retainer assembly of the embodiment of FIG. 7a shown in a partially disassembled configuration and an operating configuration, respectively;

FIGS. 9a and 9b are perspective views of a PRIOR art packing puller;

FIG. 9c is a perspective view of a packing puller threadably attached to a packing retainer assembly of the embodiment of FIG. 7a; and

FIGS. 10a-10c are perspective views of a packing puller threadably attached to a packing retainer assembly of the embodiment of FIG. 7a and removing same from a stuffing box.

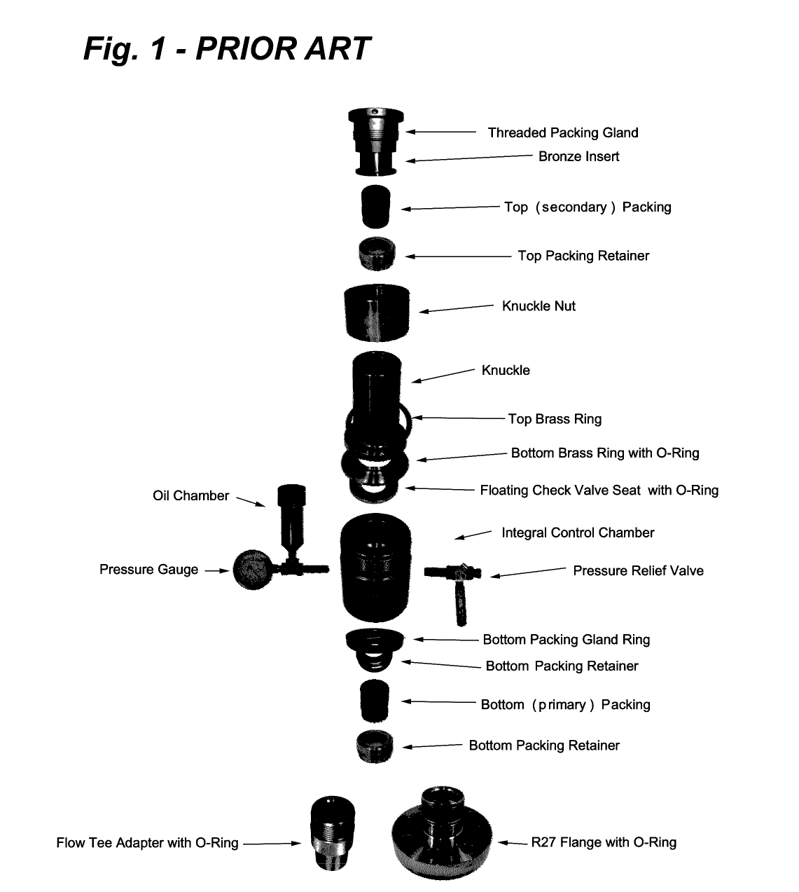

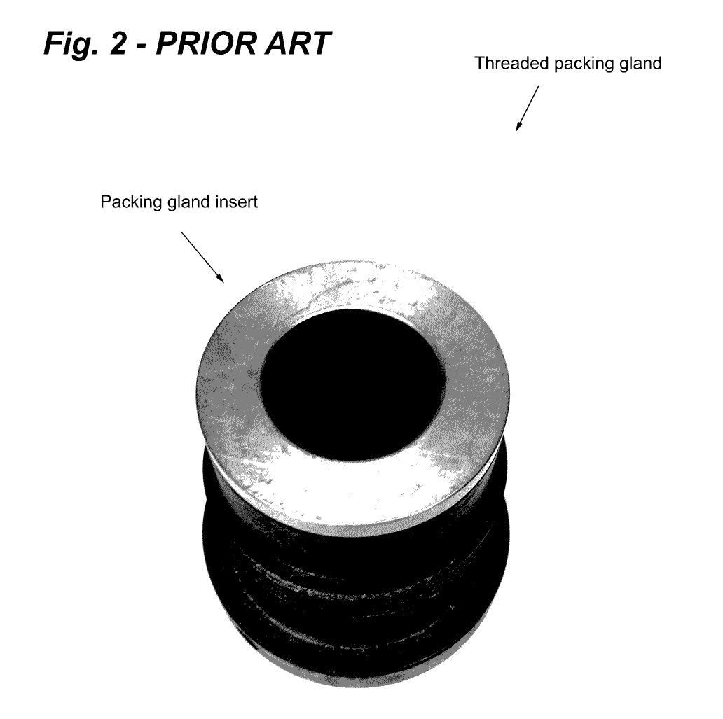

### DETAILED DESCRIPTION OF THE PREFERRED EMBODIMENTS

The following description is of preferred embodiments by way of example only and without limitation to the combination of features necessary for carrying the invention into effect. Reference is to be had to the Figures in which identical reference numbers identify similar components. The drawing figures are not necessarily to scale and certain features are shown in schematic or diagrammatic form in the interest of clarity and conciseness.

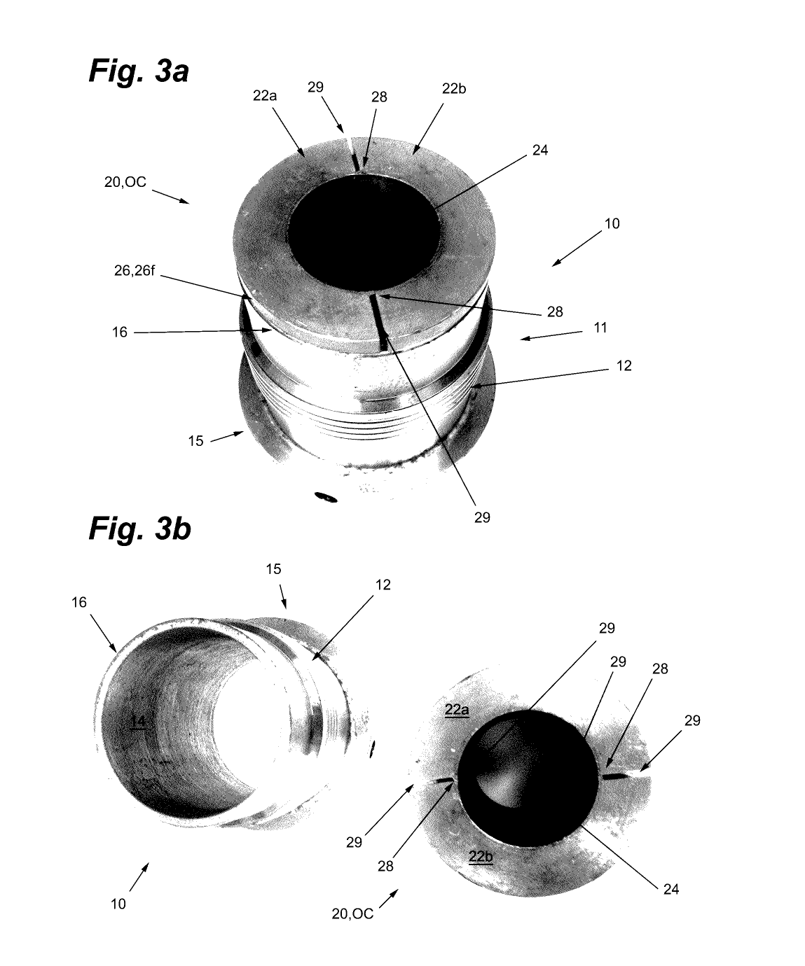

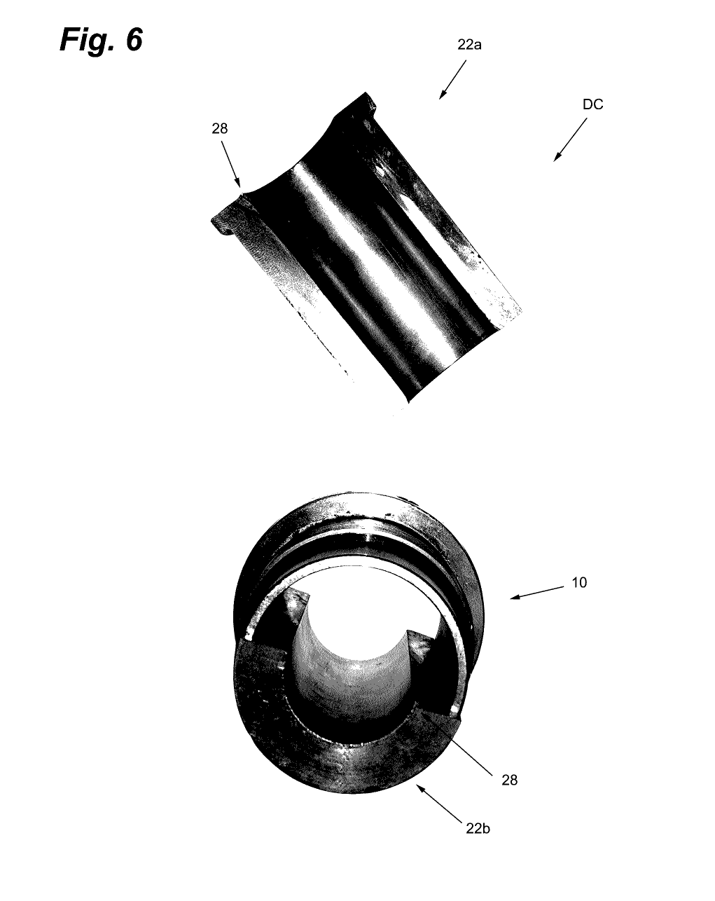

A first embodiment of a packing gland 10 with packing gland insert 20 of the present invention is shown in FIGS. 3a-6. The packing gland 10 is conventional in that it is a generally hollow cylinder having an outer surface 11 with threaded section 12 suitable for treadable connection to a stuffing box or component thereof, and an inner bore 14 suitable for accepting packing gland insert 20 therein. Packing gland 10 may have an outer end 15 that is flanged and an inner end 16 suitable for insertion into a knuckle nut or other suitable component of a stuffing box. Preferably, packing gland 10 is made from a steel alloy material, such as 4140 heat treated stress relieve steel.

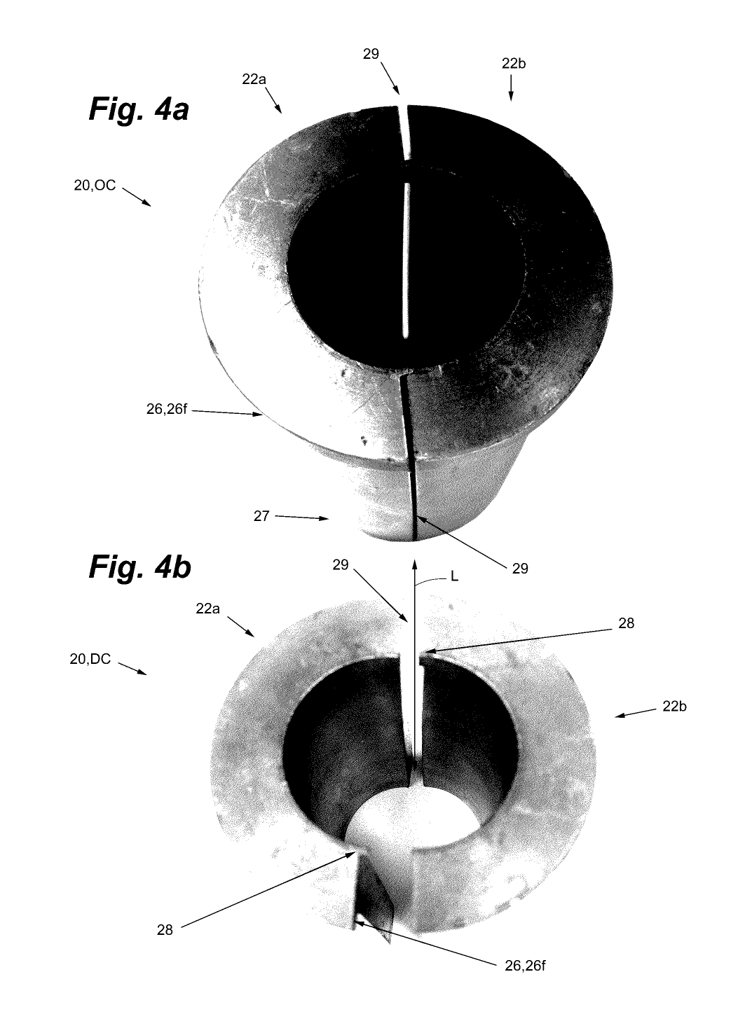

Packing gland insert 20 may be made of any suitable material (e.g. bronze or nylon) and is preferably of a softer material than the polished rod and is corrosion resistant. Packing gland insert 20 comprises a plurality of semi-cylindrical segments 22a , 22b which mate or fit together into an operating configuration OC (see FIGS. 3a, 3b and 4a). When in the operating configuration OC, segments 22a , 22b form insert 20, preferably having an outer surface which makes a close, snug and sliding fit against the wall of inner bore 14. Further, when in the operating configuration OC, the plurality of semi-cylindrical segments 22a , 22b form a substantially hollow cylinder having a longitudinal axis L with an inner bore 24 aligned therealong, a first end 26 and a second, generally opposing, end 27. Inner bore 24 is preferably dimensioned to make a close sliding fit against exterior of any polished rod. More preferably, inner bore 24 has a cross-sectional profile that is substantially circular.

In this embodiment insert 20 comprises two semi-cylindrical segments 22a , 22b . In other embodiments, not shown, insert 20 may comprise three or more semi-cylindrical segments. Packing gland insert 20 may further comprise flanged end 26f to allow insert 20 to rest on end 16 of the packing gland 10 (using flanged end 26f ) when inserted or placed substantially inside bore 14 of the packing gland 10; see FIG. 3a.

A plurality of tab or spacer members 28 join the semi-cylindrical segments 22a , 22b and maintain said segments in the desired operating configuration OC. A plurality of spaces 29 between adjacent segments 22a , 22b , along longitudinal axis L of the insert 20, may result as a function of spacer members 28 maintaining the segments 22a , 22b in the desired operating configuration OC, namely so as to keep a substantially circular cross-section in bore 24 to allow insert to make a close sliding fit against exterior of any polished rod. Typical inside diameters of bore 24 are 1½ or 1¾ inches so as to match the outside diameter of a polished rod. Typical space or clearance between segments 22a , 22b is 1/32 inch to 1/16 inch.

Preferably, packing gland insert 20 is first machined as a cylindrical member from a single piece or block of material (e.g. bronze) having the desired bore 24 dimensions and any flanged end 26, after which a slitting saw or similar cutting tool may be utilized to cut spaces 29 between each of the plurality of segments 22a , 22b . Slitting saw or similar cutting tool is then directed so as to not cut completely though said single piece of material, thereby leaving a small amount of material remaining between adjacent segments and thereby creating one or more spacer member 28. Preferably, spaces 29 between adjacent segments 22a , 22b tracks or stretches between said adjacent segments 22a , 22b for substantially all, but not the entire, length of the longitudinal axis L. If manufactured in this manner, packing gland insert 20 may be considered as an integral member comprising a plurality of segments 22a , 22b maintained as a whole by members 28.

In contrast, if such single piece of material was cut through completely (and no tab or spacer members 28 were provided), the substantially circular cross-section of bore 24 would be offset and changed into a slightly oval cross-section (due to removal of the material that used to be in spaces 29) when insert 20 is placed inside packing gland 10. Having a packing gland insert bore with a slightly oval cross-section is undesirable because: (i) insert 20 may wear unevenly against the polished rod and (ii) the tolerances between bore 24 and the outside of a polished rod are very critical to maintain the packing inside the stuffing box and maintain the proper sealing of the stuffing box.

In the embodiment of FIGS. 3a-4b, spacer members 28 are positioned near the flanged end 26. In other embodiments, spacer members 28 may be provided at end 27, or at both ends 26, 27. Advantageously, spacer members 28 maintain segments 22a , 22b together having the desired bore 24 dimensions without the need for additional components such as tape, glue or retaining rings.

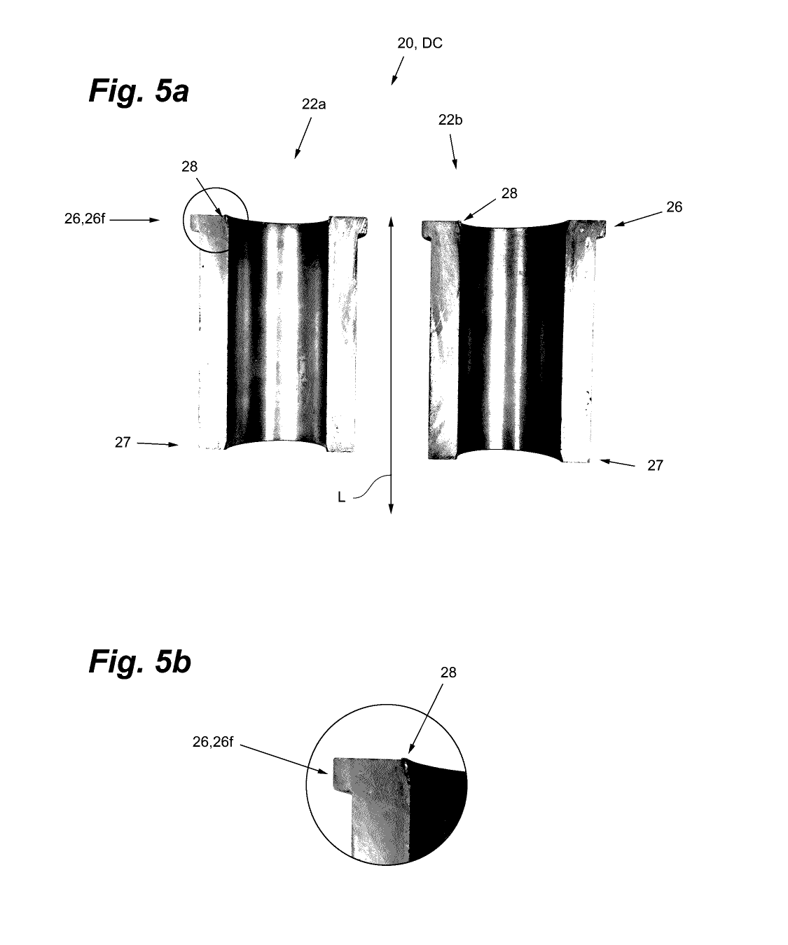

When needing to replace the packing gland insert 20, packing gland 10 may be unthreaded or removed from the knuckle nut of a stuffing box and insert 20 removed therefrom. Because spacer members 28 only comprise a small amount of material, the joint formed by them between adjacent segments (e.g. 22a , 22b ) will be weak and easily broken or snapped by an operator. This may be accomplished by hand or by insertion of a flat tool (like a flat-end screwdriver) in space 29 and giving that tool a twist. Advantageously, once adjacent segments are broken apart from each other, they can be removed from either side of the polished rod without having to fully slide off over the top end of the polished rod. Once adjacent segments are broken apart from each other, the packing gland insert 20 can be referred to as being in a disassembled configuration DC; e.g. see FIG. 5a.

Packing Retainer Assembly

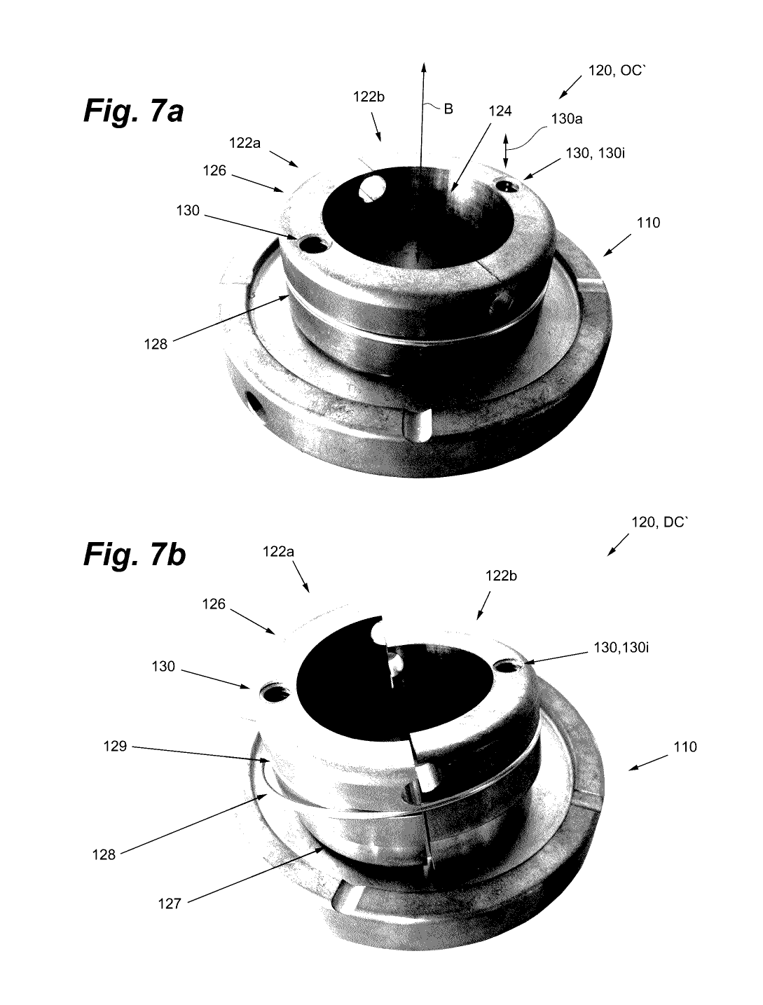

A preferred embodiment of a packing retainer assembly 120 of the present invention is shown in FIGS. 7a -8b and 9c-10c . The packing retainer 120 may be made of any suitable material (e.g. bronze or nylon) and is preferably of a softer material than the polished rod R and is corrosion resistant. Packing retainer assembly 120 comprises a plurality of semi-cylindrical segments 122a , 122b which mate or fit together into an operating configuration OC′ (see FIG. 7a). When in the operating configuration OC′, the plurality of segments 122a , 122b form a substantially hollow cylinder having a bore axis B with an inner bore 124 aligned therealong, a first end 126 and a second, generally opposing, end 127. Inner bore 124 is preferably dimensioned to make a close sliding fit against exterior of a polished rod R. More preferably, inner bore 124 has a cross-sectional profile that is substantially circular.

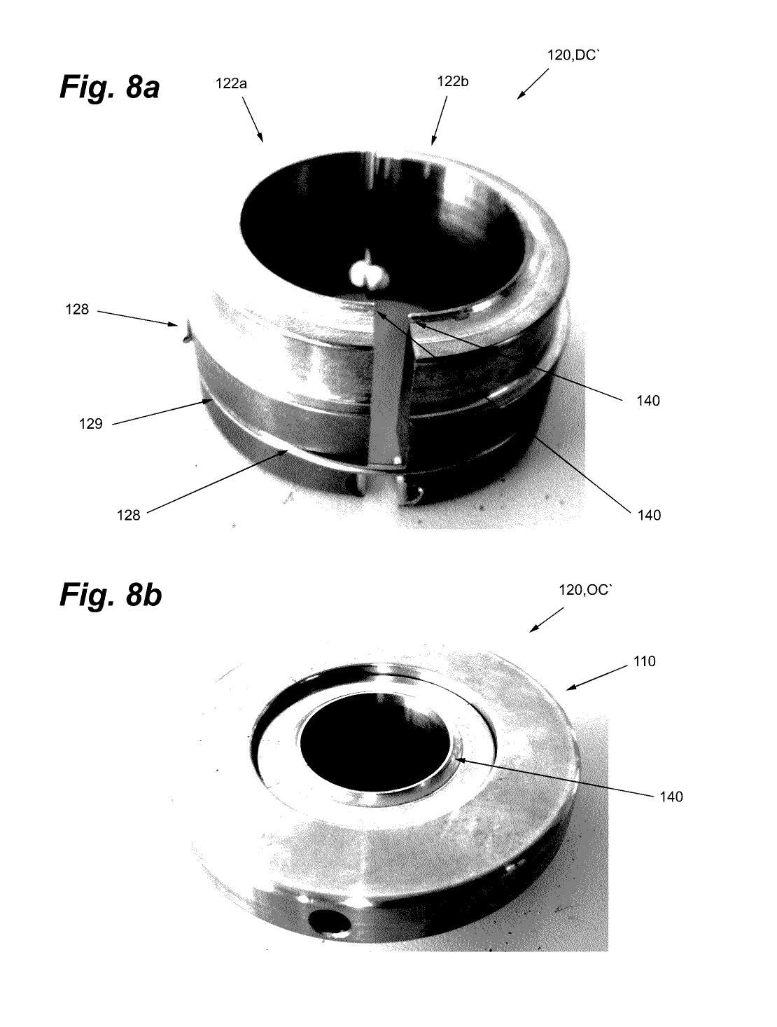

In this embodiment packing retainer assembly 120 comprises two semi-cylindrical segments 122a , 122b . In other embodiments, not shown, packing retainer assembly 120 may comprise three or more semi-cylindrical segments. Packing retainer assembly 120 may be supported, and partially captured, by a packing gland ring 110 when installed in a stuffing box; see, for example, FIGS. 7a, 7b and 8b , where the semi-cylindrical segments 122a , 122b are captured by packing gland ring 110 at end 127. During operation, packing gland ring 110, by virtue of capturing end 127, may maintain the packing retainer assembly 120 in the operating configuration OC′.

Preferably, however, a substantially circular clip member 128 is provided for fitment around the outside or exterior surface of packing retainer assembly 120 along a substantially continuous exterior groove 129 provided on each segment 122a , 122b . Substantially circular clip member 128 may also contribute to keep the packing retainer assembly 120 in the operating configuration OC′. Preferably, clip member 128 is fully captured within the depth of groove 129 so as to facilitate insertion of the packing retainer assembly 120 within the inner bore of a stuffing box S. More preferably, clip member 128 is made from a non-corrosive semi-flexible metal or other similarly strong material, so as to allow tensional forces placed on one of the plurality of segments (e.g. 122a ) to be substantially transferred to any adjacent segments (e.g. 122b ) without breaking or shearing; so that pulling or lifting on one segment (e.g. 122a ) will result in a similar pulling or lifting action on the adjacent segments (e.g. 122b ) and the packing retaining assembly 120 as a whole. Even more preferably, clip member 128 is not fully circular, but has open ends (e.g. FIG. 8a) and has sufficient flexibility or spring-like characteristics to: (i) maintain assembly in the operating configuration OC′ when installed in groove 129, and also (ii) also allow an operator to remove clip member 128 from around assembly 120 and any polished rod R, in a similar fashion to a circlip or c-clip.

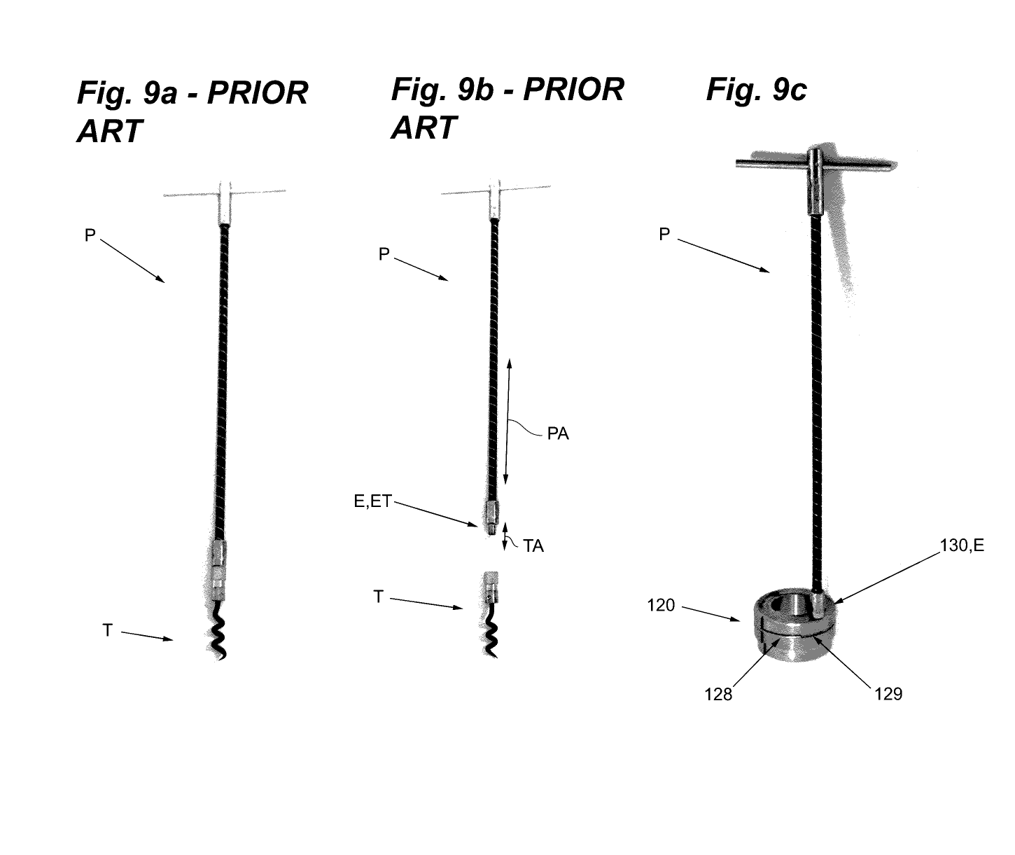

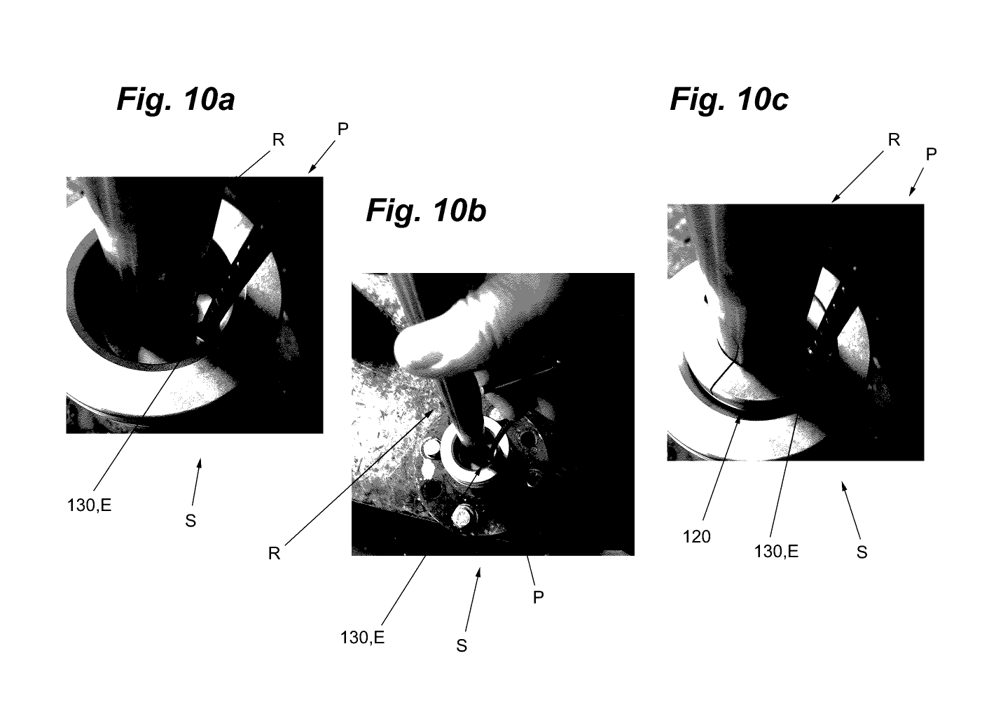

Still even more preferably, the packing retainer assembly 120 is provided with at least one threadable connection point 130 at one end 126 or 127 thereof. Threadable connection point 130 is capable of threadably engaging an elongate tool having a threaded end E which, once threadably engaged to one segment (e.g. 122a ) can transmit tensile or pulling forces from a user to said segment (e.g. 122a ). A suitable elongate tool is a conventional packing puller P having a removable packing extractor tip T threaded on an end thereon, wherein the packing extractor tip T may be untreaded and expose external threads ET on threaded end E (see FIGS. 9a-10c).

More preferably, packing puller P has a longitudinal axis PA and threaded end E has external threads ET wrapped around a thread axis TA, wherein thread axis TA is substantially parallel to the longitudinal axis PA of the packing puller. Likewise, and even more preferably, the threadable connection point 130 has corresponding internal threads 130i around a thread axis 130a that is substantially parallel to the bore axis B. Advantageously, when packing puller P (without extractor tip T) is inserted into a stuffing box S, then threaded end E can be easily threaded into connection point 130, alongside any polished rod R around which assembly 120 may be placed; see FIGS. 9c-10c.

Advantageously, a user or operator can use such elongate tool P to reach down into a partially disassembled stuffing box, threadbly engage one segment (e.g. 122a at point 130) and then provide a tensile or pulling force to all segments (122a , 122b ) and the packing retainer assembly 120 as a whole, by way of clip member 128; thereby easily removing packing retainer assembly 120 from a stuffing box. More advantageously, a plurality of connection points 130 are provided in a spaced configuration around one or more ends 126, 127, so as to present easy threadable access to the packing retainer assembly 120, regardless of which side of a polished rod R an operator may happened to be positioned at, when servicing a stuffing box S. Even more advantageously, once packing retainer assembly 120 is removed from a stuffing box S, clip member 128 can be removed and segments 122a , 122b may be easily removed from either side of the polished rod R without having to fully slide off over the top end of said polished rod R.

Preferably, packing retainer assembly 120 is provided with a substantially circumferential lip or edge 140 at one or more ends 126, 127, along the circumference of bore 124 and adapted to make a close, snug and sliding fit against exterior of any polished rod R; e.g. see FIG. 8b. More preferably, circumferential lip 140 is provided at an end (126 or 127) that is distal to any packing that may be in a stuffing box S when assembly 120 is inserted therein. Advantageously, during operation of a stuffing box, lip 140 can then function to scrap or remove any wax or condensate build-up from the polished rod that may accumulate over time and which could otherwise damage, or prematurely wear, any packing that may be inside a stuffing box S. More advantageously, circumferential lip 140 is positioned on assembly 120 so as to direct any scrapped wax or condensate back down into the wellbore or into a collection area inside the stuffing box S, away from any packing that may be in the stuffing box S.

Those of ordinary skill in the art will appreciate that various modifications to the invention as described herein will be possible without falling outside the scope of the invention. In the claims, the word “comprising” is used in its inclusive sense and does not exclude other elements being present. The indefinite article “a” before a claim feature does not exclude more than one of the features being present.

1. A packing gland insert having a longitudinal axis and for use with a packing gland of a stuffing box and a polished rod, comprising:
a plurality of segments;
a plurality of spacer members to join one of said plurality of segments with any adjacent segments;
wherein when all of said plurality of segments are joined to adjacent segments, the packing gland insert is in an operating configuration; and
wherein when the packing gland insert is in the operating configuration, a space results between each set of adjacent segments;
wherein when the packing gland insert is in the operating configuration, said plurality of segments form an inner bore along the longitudinal axis of the packing gland insert; and
wherein said inner bore is of such dimensions so as to allow the packing gland insert to have a close, sliding fit against exterior of the polished rod.

2. The packing gland insert of claim 1, wherein the space between adjacent segments tracks along substantially all, but not the entire, length of the longitudinal axis.

3. The packing gland insert of claim 1, wherein the inner bore has a substantially circular cross-sectional profile when the packing gland insert is in the operating configuration.

4. The packing gland insert of claim 1, wherein the plurality of spacer member are suitable to allow an operator to break said insert into a disassembled configuration.

5. The packing gland insert of claim 1, wherein the plurality of segments and plurality of spacer members are all constructed from a single block of initial material.

6. The packing gland insert of claim 5, wherein said single block is of bronze material.

7. A packing retainer assembly having a bore axis for use with a stuffing box and a polished rod, comprising:
a plurality of segments;
a substantially circular clip member suitable for fitment around the exterior surface of the plurality of segments;
wherein, when said plurality of segments are arranged in an operating configuration, an inner bore is formed along the bore axis;
wherein said inner bore is of such dimensions so as to allow the packing retainer to have a close, sliding fit against exterior of the polished rod; and
wherein, said clip member is adapted to allow tensional forces placed on one of the plurality of segments to be substantially transferred to any adjacent segments.

8. The packing retainer assembly of claim 7, further comprising a substantially continuous exterior groove on each of the plurality of segment, said exterior groove suitable to fully capture the substantially circular clip member.

9. The packing retainer assembly of claim 8 wherein the plurality of segments when arranged in the operating configuration provide a first end and a second, generally opposing end, the assembly further comprising at least one threadable connection point at either the first end or the second end.

10. The packing retainer assembly of claim 9, further comprising a substantially circumferential lip at either the first end or the second end, said circumferential lip adapted to make a close, snug and sliding fit against the polished rod.

11. The packing retainer assembly of claim 9, wherein the threadable connection point has threads wound around a thread axis; and
wherein the thread axis is substantially parallel to the bore axis.

12. A stuffing box assembly comprising:
at least one packing gland insert according to claim 1; and
at least one packing retainer assembly according to claim 7.
